(19) United States
(12) Patent Application Publication
(10) Pub. No.: US 2015/0242844 A1
(43) Pub. Date: Aug. 27, 2015

(54) SYSTEM AND METHOD FOR SECURE REMOTE ACCESS AND REMOTE PAYMENT USING A MOBILE DEVICE AND A POWERED DISPLAY CARD

(71) Applicant: POWERED CARD SOLUTIONS, LLC, Lakeland, FL (US)

(72) Inventors: Shimon Yisraelian, Nes Ziona (IL); Ronen Shaul, Kiriat Bialik (IL)

(21) Appl. No.: 14/435,615

(22) PCT Filed: Oct. 15, 2013
(86) PCT No.: PCT/US13/64951

§ 371 Date: Apr. 14, 2015

Related U.S. Application Data
(60) Provisional application No. 61/713,701, filed on Oct. 15, 2012.

(51) Int. Cl. G06Q 20/34; G06Q 20/40; H04W 4/00

(52) U.S. Cl. CPC G06Q 20/353; H04W 4/008; G06Q 20/341; G06Q 20/352; G06Q 20/409

(57) ABSTRACT

A system for authentication is provided which comprises an NFC card containing authentication data and a mobile communication device which can communicate with the card and a remote authentication server. The card, when activated, transmits authentication data stored on the card to the remote authentication server via the mobile communication device. The authentication server then transmits an authentication result to the mobile communication device. The authentication result can be used to complete a transaction such as a financial transaction. Either the card or the mobile communication device can contain the transaction data such as the user's account information needed to complete the transaction. The system can be used for secure remote access and re mote payment. A method of using the card is also provided.

### BACKGROUND

1. Field

This application provides a set of functional and technical concepts, as well as proposed methods, all related to secure remote access and remote payment via modern mobile devices such as smartphones. The required additional security is achieved by combining a secure powered display card that can wirelessly communicate with the mobile device when brought into proximity.

2. Background of the Technology

Networked mobile devices provide great flexibility in remote access and remote payment, by their ability to be connected to the internet via the mobile network or any available wireless network such as WiFi, and at the same time provide a variety of dedicated applications for the user, making use of this connectivity for easy remote payment-oriented transactions. Examples can include online shops, public transportation systems, parking, vending machines, as well as transactions and operations performed directly to the bank account. It is also known that smartphones from leading vendors will feature near field communication (NFC) as a general purpose proximity interface. Remote payment with mobile devices such as smart phones, however, has some inherent security weaknesses. Mobile devices, as permanently online terminals, are subjected to common hacker threats such as malicious software (viruses, Trojan horses, spyware etc.) that can easily be installed ‘over the air. As devices in mobile networks smartphones can also be exposed to fake cellular ‘networks’, presenting fake payment and merchant sites. Any authentication mechanism provided by the smartphone itself is inherently weak, since its secret keys must reside in the mobile device's main memory, hence can be easily accessed by the above mentioned hacking methods.

Mobile phones are typically not kept safe by customers in the same manner as credit cards and tend to be lost or stolen frequently.

The payment market is gradually migrating to using mobile devices as smart payment tools, either locally (NFC) or remotely. Therefore a solution for the inherent security weaknesses is essential.

The chip-based credit card is known as a secured device since it is not connected to any network and has a long history of protection against hacking. As described herein, such a card can be used in conjunction with the mobile device in order to provide strong yet simple to operate authentication mechanism to the transaction, and in some cases even to perform the transaction itself, the mobile device being the network terminal only.

### SUMMARY

A system for secure remote transactions, access and payments via mobile devices is provided. The system comprises:

a powered card with an electronic circuit, which comprises a secure chip, a display, a Near Field Communication (NFC) compliant interface, and a battery, wherein the secure chip contains an authentication tool and, optionally, payment protocols;

a mobile device, wherein the mobile device includes a payment application and an NFC interface that enables proximity communication between the mobile device and the card;

an authentication entity that store's personal data of the user and authentication keys, and that can be used for remote online authentication; and

a remote payment entity, wherein the mobile device's payment application can communicate with the remote payment entity;

wherein the card can be used as an authentication tool.

Remote online authentication can be accomplished by password generation or any other selected authentication mechanism.

A method for secure remote payment is provided which comprises:

activating a powered display card and locating it in proximity to the mobile device so that the NFC interface can be active.

performing an authentication cycle between the card and a remote authentication entity, the mobile device being a network gateway;

presenting the authentication result on the mobile device and/or on the display of the card; and

performing a payment transaction by the mobile device's application, based on the authentication result.

The card used in the method can be a powered card as described above. The authentication transaction can be a simple OTP, or a more complex one-way or two-way challenge response mechanism.

According to some embodiments, the card also has payment capabilities, such as defined by EMV (Europay, MasterCard and Visa) global standard for inter-operation of integrated circuit cards). In such cases the payment itself can also be performed by the card, while communication with the remote payment entity via the mobile device.

These and other features of the present teachings are set forth herein.

### BRIEF DESCRIPTION OF THE DRAWINGS

The skilled artisan will understand that the drawings, described below, are for illustration purposes only. The drawings are not intended to limit the scope of the present teachings in any way.

FIG. 1 is a schematic representation of the proposed secured payment mobile system with secured display card.

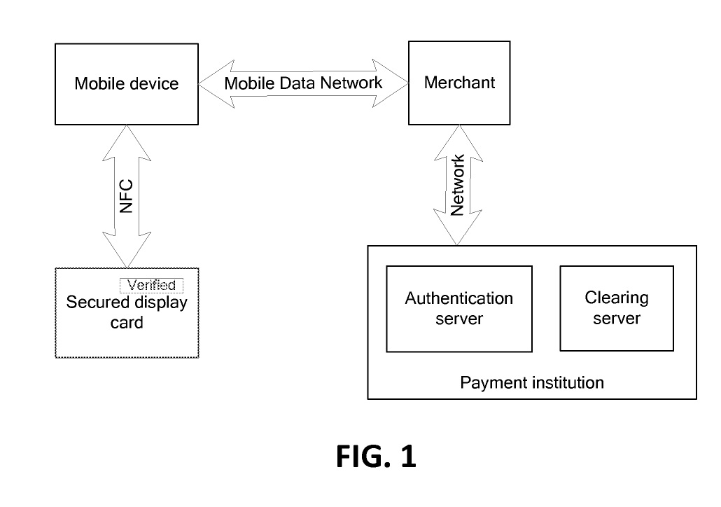

FIG. 2 is a schematic representation of the payment and authentication steps in the proposed system where the secured display card is the authentication device and the mobile communication device is the payment device. In this example the authentication used is a two-way challenge response protocol.

FIG. 3 is a schematic representation of the payment and authentication steps in the proposed system where the secured display card is both the authentication device and the payment device.

### DESCRIPTION OF THE VARIOUS EMBODIMENTS

A method of adding a security level to mobile payment devices by using a secured display card is provided. The secured display card is used with a mobile device such as a smart phone to enable secured mobile payment, without sacrificing ease of use or adding significant complexity to the payment process.

According to some embodiments, the secured display card is a fully functional payment card that can be used as is in card-present situations, and potentially a fully functional authentication token that makes use of its display for secure remote access.

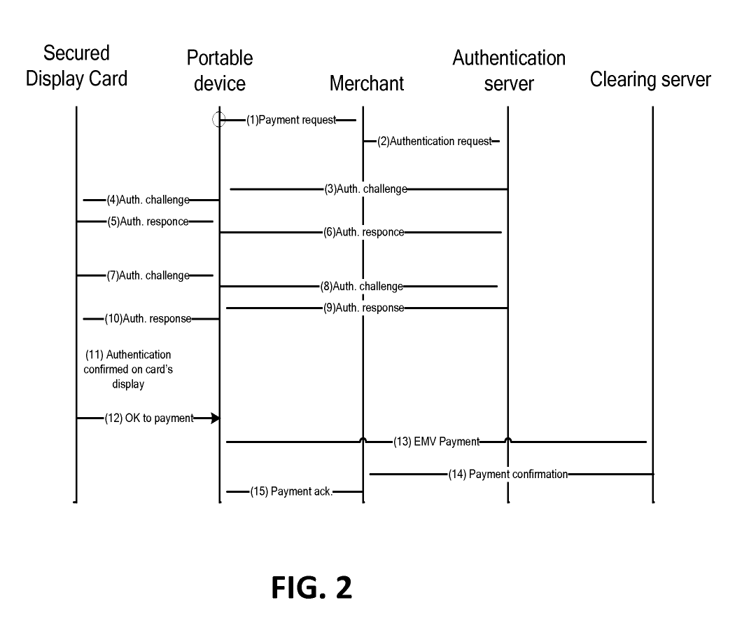

According to some embodiments, the mobile device is a payment device holding the owner's payment data. The secured display card is used in the process of payment and acts as an automatic authentication device. A system of this type is shown in FIG. 2. FIG. 2 is a schematic representation of the payment and authentication steps in the proposed system where the secured display card is the authentication device and the mobile device is the payment device.

The Secured Display Card as an Authentication Device

According to this embodiment, the mobile device is used as the paying device. Accordingly, the mobile device can have an installed payment application and transaction data, including a set of the owner's banking details, for performing remote payment transactions with the bank or the clearing system. The secured display card acts as a strong authentication device, enhancing the overall security level of the transaction by adding one way or two way authentication cycles prior to the payment itself. This is done by communication between the secured display card and the mobile communication device using the NFC interface.

As an authentication device, the card can hold a personal authentication secret or key (i.e., seed) in a highly secured embedded memory. This key, just like any authentication token, can be programmed into the card as part of the process of issuing the card to its holder.

An authentication process is carried out with a remote authentication server, a separate entity in the bank or the clearing system that has a secure database of all the keys of all the issued tokens. The mobile phone has no access to this key, and it only provides connectivity to the authentication server.

Just like any OTP token, the secured display card providing automatic or semi-automatic authentication to a mobile communication device is not a payment device and hence does not require any certification.

Payment Description

Stage 1: Secured Display Card Activation

The secured display card can be activated automatically (e.g., by detecting the NFC field of the mobile communication device) or manually (e.g., by pressing a button on the card or by typing a PIN on the card's keypad).

Stage 2: Authentication—FIG. 2. Steps 1 Through 10

Authentication can be a separate application manually activated on the mobile communication device or part of the payment application. At this stage, the mobile communication device acts as a communication gateway and connects to the card via the NFC interface and to the remote Authentication Server via the phone network. The card holder's authentication data (e.g. ID) is transferred to the remote authentication server for seed extraction. The authentication can be a simple OTP such as the Initiative for Open Authentication (OATH) Time-based One-time Password Algorithm or OATH TOTP generated by the card and transferred to the Authentication Server, with a confirmation message transferred back. The authentication can also be a more complex one-way or two-way challenge-response mechanism such as the OATH Challenge/Response Algorithm or OCRA), where both sides confirm each other. In both cases, data exchange between the card and the server via the phone can be completely automatic. The authentication result is then presented on the card's display and/or on the phone.

Stage 3: Payment—FIG. 2 Steps 11 Through 15

The actual payment can now be executed. At this stage, the mobile device acts as a payment device, providing the owner's payment data to the bank or clearing system. If manual association is in use, the owner manually activates or cancels the payment transaction according to the authentication result presented on the card. If automatic association is in use, the phone's payment application automatically performs or cancels this stage of the process accordingly.

A high level of security can be achieved using this process, particularly if the card is turned off and carried separate from the phone and the authentication is time based. This prevents any ‘trojan horse’ or other malicious application on the phone from performing any transaction without the knowledge of the owner.

According to further embodiments, the card is activated by locating the card near the smart device NFC field without pressing button. The card detects the field and activates automatically to complete the required operation.

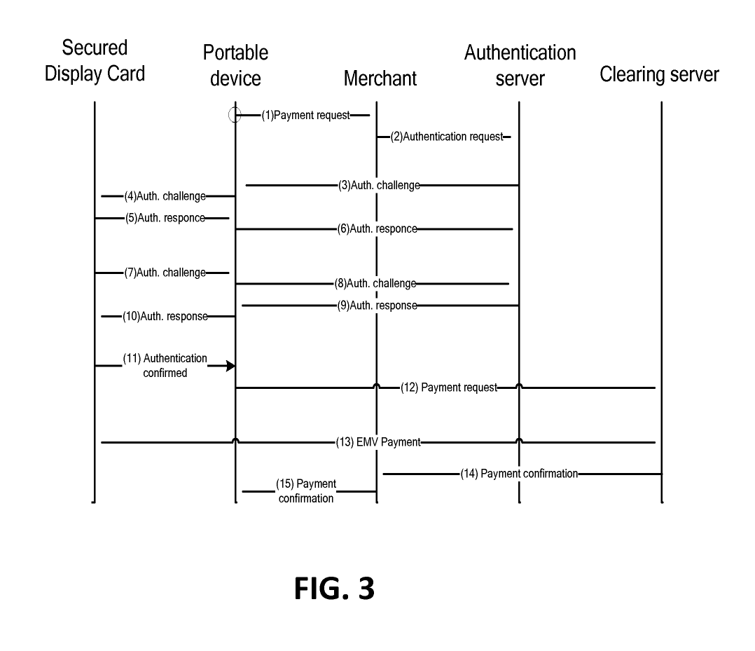

According to some embodiments, a method can be used for payment wherein a mobile device acts as an on-line payment terminal and holds no payment data. The secured display card, now being used as the payment device, makes use of the mobile device's connectivity for securely connecting to the banking clearing infrastructure and executing the transaction. A system of this type is shown in FIG. 3. FIG. 3 is a schematic representation of the payment and authentication steps in the proposed system where the secured display card is both the authentication device and the payment device.

The Secured Display Card as a Payment and Authentication Device

In this method, it is assumed that the paying device, which is the secured display card, runs an EMV certified payment application. This application holds the owner's banking details, and can either act with an external payment terminal (such as a cash register or an ATM) or with a mobile communication device that provides payment terminal functionality.

When operating in conjunction with a smartphone, the phone's application provides network access and connectivity, as well as interactive tools for flexibility and easy operation, while the actual payment is performed by the secured display card.

The payment application on the secured display card is an extended one, performing authentication with a remote authentication server prior to the actual payment, as a tool to overcome otherwise unavoidable security issues in a cellphone-based terminal. Both the authentication seed and the payment data are securely kept in the secured display card, and are used in the various stages of the transaction mechanism. The user only works with the phone's application, unaware of the fact that the paying device is in fact the attached card.

Payment Description

Stage 1: Secured Display Card Activation

The secured display card is activated by pressing a button on the card, and optionally typing a PIN on the card's keypad. The card then communications with the mobile communication device via the NFC interface.

Stage 2: Activating the Payment Application on the Phone

The user can manage the payment application as an interactive process on the smartphone. The phone acts as an on-line terminal throughout the process till reaching the actual payment stage (i.e., ‘store checkout’).

Stage 3: Authentication FIG. 3 Steps 1 Through 10

Upon activating the ‘payment’ stage on the mobile device, the mobile device becomes a communication gateway and requests the secured display card to perform the actual payment. The secured display card connects to the remote authentication server via the mobile communication device and performs the authentication process automatically. The authentication can be a simple OTP or any challenge-response mechanism, as previously described.

Stage 4: Payment—FIG. 3 Steps 11 Through 15

Payment can now be executed automatically, via the mobile communication device's gateway operation, now with the bank or clearing system servers. The EMV protocol messages are conveyed both ways by the mobile communication device over the mobile network and the NFC interface accordingly.

While the foregoing specification teaches the principles of the present invention, with examples provided for the purpose of illustration, it will be appreciated by one skilled in the art from reading this disclosure that various changes in form and detail can be made without departing from the true scope of the invention.

What is claimed is:

1. A system for remote payment comprising:
a card comprising a display, a chip connected to the display and a near field communication (NFC) device, wherein the chip contains authentication data;
a mobile device which can communicate with the card via the NFC device; and
a remote authentication server, wherein the mobile device can communicate with the remote authentication server;
wherein the card, when activated, transmits the authentication data to the remote authentication server via the mobile communication device;
wherein the authentication server authenticates the authentication data and transmits an authentication result to the mobile device; and
wherein the authentication result can be used to complete a transaction.

2. The system of claim 1, wherein the chip is a Europay, MasterCard and Visa (EMV) class device capable of secure payment.

3. The system of claim 1, further comprising a relay station, wherein the mobile device communicates with the remote authentication server via the relay station.

4. The system of claim 2, wherein the relay station is a cellular or non-cellular network router.

5. The system of claim 1, further comprising a payment device.

6. The system of claim 4, wherein the payment device is a contactless card reader.

7. The system of claim 1, wherein the card comprises transaction data and wherein the transaction data can be transferred to a remote transaction server via the mobile communication device.

8. The system of claim 1, where the card is automatically activated by the NFC field of the mobile device.

9. The system of claim 1, wherein the card complies with version 4.3 of the Europay, MasterCard and Visa (EMV) payment standard or another secured payment standard.

10. The system of claim 1, wherein the mobile device is a portable device operating in a cellular network.

11. The system of claim 1, wherein the mobile device is a portable device operating in Wifi combined with a cellular network.

12. The system of claim 1, wherein authentication of the card is event based.

13. The system of claim 1, wherein authentication of the card is time based.

14. The system of claim 1, wherein authentication is a one-time password algorithm (OTP) or a two-way challenge response algorithm.

15. The system of claim 1, wherein the display is a bit map or segmented display.

16. The system of claim 1, wherein the system complies with version 4.3 of the Europay, MasterCard and Visa (EMV) standard for authenticating credit and debit card transactions.

17. The system of claim 1, wherein the user manually confirms the mobile payment upon successful authentication presented on the card.

18. The system of claim 1, wherein an application on the mobile device automatically performs payment upon successful authentication signaled by the card.

19. The system of claim 1, wherein the mobile device runs an operating system (OS) selected from the group consisting of Android and iOS.

20. The system of claim 1, wherein the mobile device comprises an application for remote payment.

21. The system of claim 1, wherein the mobile device comprises an application for remote access.

22. A method of authentication comprising:
activating a card comprising a display, a chip connected to the display and a near field communication (NFC) device, wherein the chip contains authentication data for the transaction;
transferring the authentication data from the chip to a remote server using a mobile device, wherein the mobile device connects to the card using an NFC interface and to the remote authentication server using a phone network;
authenticating the authentication data on the remote server to generate an authentication result; and
presenting the authentication result on the mobile communication device and/or on the display of the card;
wherein the authentication result can be used to complete a transaction.

23. The method of claim 16, further comprising activating or canceling the transaction based on the authentication result.

24. The method of claim 16, wherein the card is activated by pressing a button on the card and/or by entering a code into the card via a key pad on the card.

25. The method of claim 16, wherein authentication data is transferred from the mobile device to the remote authentication server by manually activating the transfer on the mobile device.

26. The method of claim 16, wherein authentication data is automatically transferred from the mobile device to the remote authentication server after activating the card.

27. The method of claim 16, wherein the authentication result is a one time password.

28. The method of claim 16, wherein authentication comprises a one-way or two-way challenge-response mechanism.

29. The method of claim 17, further comprising transferring transaction data to a remote transaction server system using the mobile device if the transaction is activated.

30. The method of claim 17, wherein the transaction is manually activated or manually canceled using the mobile device.

31. The method of claim 17, wherein the transaction is automatically activated or canceled using an application on the mobile device.

32. The method of claim 16, wherein authentication is time based.

33. The method of claim 16, wherein the card is activated automatically upon detection of the NFC field generated by the mobile device.

34. The method of claim 23, wherein transaction data is stored on the card.

35. The method of claim 23, wherein transaction data is stored on the mobile device.

36. The method of claim 28, wherein the transaction is manually activated or canceled using the card.

37. The method of claim 16, wherein the mobile device is a smart phone.

38. A system comprising:
a powered card with an electronic circuit, wherein the powered card comprises a secure chip, a display, a Near Field Communication (NFC) compliant interface, and a battery, wherein the secure chip contains an authentication tool and, optionally, payment protocols;
a mobile device, wherein the mobile device includes a payment application and an NFC interface that enables proximity communication between the mobile device and the card;
an authentication entity that store's personal data of a user of the card and authentication keys, and that can be used for remote online authentication; and
a remote payment entity, wherein the mobile device's payment application can communicate with the remote payment entity;
wherein the card can be used as an authentication tool.
